(19) United States
(12) Patent Application Publication
(10) Pub. No.: US 2017/0154467 A1
(43) Pub. Date: Jun. 1, 2017

(54) PROCESSING METHOD AND DEVICE FOR PLAYING VIDEO

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xuelian HU, Tianjin (CN)

(21) Appl. No.: 15/245,111

(22) Filed: Aug. 23, 2016

Related U.S. Application Data
(63) Continuation of application No. PCT/CN2016/087653, filed on Jun. 29, 2016.

(30) Foreign Application Priority Data
Nov. 26, 2015 (CN) 201510847593.X

(51) Int. Cl. G06T 19/00; G06T 3/40

(52) U.S. Cl. CPC G06T 19/006; G06T 3/40; G06T 2200/04

(57) ABSTRACT

Embodiments of the present disclosure disclose a processing method and device for playing a video. The method comprises detecting data frames of a target video to determine reveal field depth information corresponding to the target video; adjusting position information of a target seat according to the reveal field depth information and a preset ideal visual distance; playing the target video on a screen on the basis of the adjusted position information. According to the embodiments of the present disclosure, the position of an audience seat is adjusted according to the field depth information of different videos; in such a way, a distance between the audience seat and the screen in a virtual cinema can be dynamically adjusted, and the 3D effect of playing videos on a mobile terminal is guaranteed.

### CROSS-REFERENCE TO RELATED APPLICATIONS

The present disclosure is a continuation of International Application No. PCT/CN2016/087653, which is based upon and claims priority to Chinese Patent Application No. 201510847593.X, entitled “PROCESSING METHOD AND DEVICE FOR PLAYING VIDEO”, filed on Nov. 26, 2015, the entire contents of all of which are incorporated herein by reference.

### TECHNICAL FIELD

The present disclosure generally relates to the technical field of virtual reality, and in particular relates to a processing method for playing a video and a processing device for playing a video.

### BACKGROUND

VR (Virtual Reality), namely virtual reality technology, is a multi-dimensional sense environment including visual sense, audial sense and tactile sense, all or part of which is generated by a computer. By means of auxiliary sensing equipment such as a helmet-mounted display, a data glove, and the like, a multi-dimensional human-machine interface is provided for a user to observe and interact with a virtual environment, such that the user can enter the virtual environment to directly observe internal changes of things and interact with the things; it provides the user a sense of reality, like being personally on the scene.

With the rapid development of the VR technology, a VR cinema system based on a mobile terminal is also developed rapidly. In the VR cinema system based on the mobile terminal, it needs to set a distance between an audience seat and a screen, such that a user can feel like watching a film in the audience seat in the virtual cinema.

At present, for all the VR cinema systems based on the mobile terminals, fixed positions of audience seats are preset without considering the field depth range difference of different 3D (Three-Dimensional) videos. Specifically, the VR cinema systems based on the mobile terminals employ the same screen size and audience seal position for all 3D videos, wherein a visual distance by which a user watches a video is determined by the distance between the positions of the screen and the audience seat. However, for different 3D videos, the field depth ranges are different. If the position of the audience seat is too close to the screen, the user may feel oppressed while watching and can be tired easily over time; if the position of the audience seat is too far away from the screen, the 3D effect is not obvious. Apparently, in the existing VR cinema systems based on the mobile terminals, in some cases, the 3D effects of videos are not obvious, or users may feed oppressed when watching films.

The existing VR cinema systems based on the mobile terminals cannot achieve the purpose of playing videos within all field depth ranges at the 3D effect, i.e., there does exist the problem of poor 3D effect of playing.

### SUMMARY

The technical problem to be solved by embodiments of the present disclosure is to provide a processing method for playing a video, which is intended to the field depth information of different videos, and meant to dynamically adjust the distance between an audience seat and a screen in a virtual cinema, thereby ensuring the 3D effect of playing videos on a mobile terminal.

Accordingly, also provided by the embodiments of the present disclosure is a processing device for playing video, which is intended to ensure the implementation and application of the above method.

According to one aspect of the present disclosure, the embodiments of the present disclosure disclose a processing method for playing a video, which includes:
detecting data frames of a target video to determine reveal field depth information corresponding to the target video;
adjusting position information of a target seat according to the reveal field depth information and a preset ideal visual distance;
playing the target video on a screen on the basis of the adjusted position information.

According to the other aspect of the present disclosure, the embodiments of the present disclosure disclose a processing device for playing a video, which includes at least one processor; and a memory communicably connected with the at least one processor for storing instructions executable by the at least one processor, wherein execution of the instructions by the at least one processor causes the at least one processor to:
detect data frames of a target video to determine reveal field depth information corresponding to the target video;
adjust position information of a target seat according to the reveal field depth information and a preset ideal visual distance;
play the target video on a screen on the basis of the adjusted position information.

According to yet another aspect of the present disclosure, provided is a non-transitory computer-readable medium storing executable instructions that, when executed by an electronic device, cause the electronic device to: detect data frames of a target video to determine reveal field depth information corresponding to the target video; adjust position information of a target seat according to the reveal field depth information and a preset ideal visual distance; play the target video on a screen on the basis of the adjusted position information.

Compared with the prior art, the embodiments of the present disclosure have the following advantages.

In the embodiments of the present disclosure, a VR cinema system based on a mobile terminal is capable of determining the reveal field depth information corresponding to a target video by detecting the data frames of the target video, and adjusting the position information of a target seat according to the reveal field depth information and the ideal visual distance, namely adjusting the position of an audience seat with regard to the field depth information of different videos, thereby dynamically adjusting the distance between the audience seat and the screen in the virtual cinema; as a result, the problem of poor 3D effect of playing due to the fixed position of the audience seat in the virtual cinema is solved, the 3D effect of playing videos on the mobile terminal is guaranteed, and the film-watching experience of a user is enhanced.

The above descriptions are merely the summary of the technical solutions of the present disclosure. In order to understand the technical means of the present disclosure more clearly, implementation can be carried out according to the contents of the description. Additionally, in order to make the above and other objectives, features and advantages of the present disclosure more obvious and understandable, specific embodiments of the present disclosure are described below.

### BRIEF DESCRIPTION OF THE DRAWINGS

In order to describe the embodiments of the present disclosure or technical solutions in the prior art more clearly, accompanying drawings needing to be used in the descriptions of the embodiments or the prior art will be introduced below briefly. It would be obvious that the accompanying drawings in the descriptions below are some embodiments of the present disclosure, and for a person ordinarily skilled in the art, other drawings may also be obtained according to the accompanying drawings without creative labor.

FIG. 1 is a step flow diagram of an embodiment of a processing method for playing a video of the present disclosure.

FIG. 2 is a step flow diagram of a preferred embodiment of a processing method for playing a video of the present disclosure.

FIG. 3A is a structural block diagram of an embodiment of a processing device for playing a video of the present disclosure.

FIG. 3B is a structural block diagram of a preferred embodiment of a processing device for playing a video of the present disclosure.

FIG. 4 exemplarily shows a block diagram of an electronic device for executing a method according to the present disclosure.

FIG. 5 exemplarily shows a storage unit for holding or carrying program codes for implementing a method according to the present disclosure.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Obviously, the described embodiments are part of embodiments of the present disclosure, not all embodiments. Based on the embodiments in the present disclosure, all the other embodiments obtained by people ordinarily skilled in the art without creative labor should fall into the scope of protection of the present disclosure.

Aiming at the above problem, one core concept of the embodiments of the present disclosure is to determine reveal field depth information corresponding to a target video by detecting data frames of the target video, and adjust position information of a target seat according to the reveal field depth information and an ideal visual distance, namely adjusting a position of an audience seat with regard to the field depth information of different videos; as a result, the problem of poor 3D effect of playing due to the fixed position of an audience seat in a virtual cinema is solved, and the 3D effect of playing videos on the mobile terminal is guaranteed.

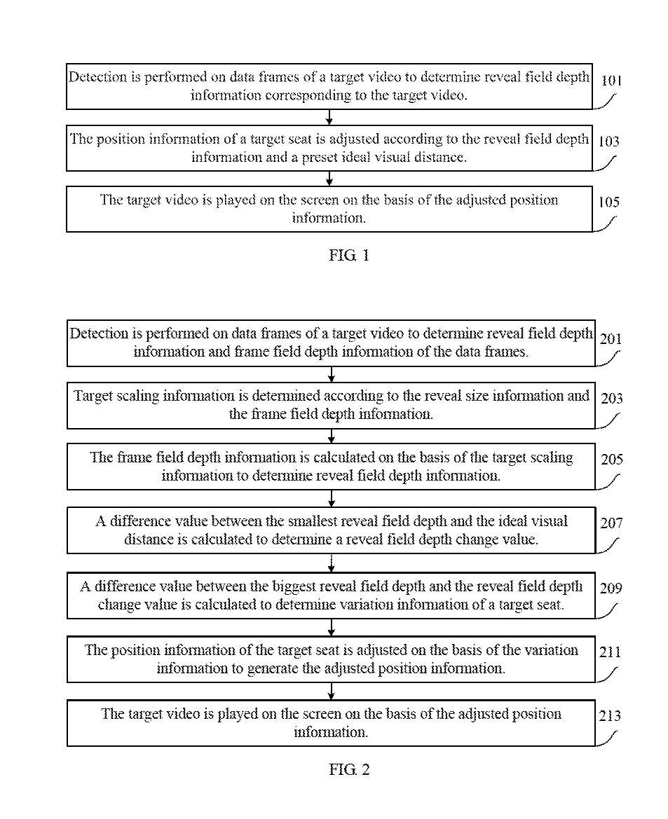

By referring to FIG. 1, illustrated is a step flow diagram of an embodiment of a processing method for playing a video of the present disclosure. Specifically, the following steps may be included.

Step 101, detection is performed on data frames of a target video to determine reveal field depth information corresponding to the target video.

In the process of playing a 3D video (e.g., a 3D film), a VR cinema system based on a mobile terminal may regard a 3D video played at present as the target video. The VR system based on the mobile terminal may determine the reveal size information, such as width WA height H, and the like, of each data frame by detecting each data frame of the target video; also, the field depth of each data frame may be determined, and therefore, the frame field depth information D of the target video is generated. The frame field depth information D may include, but is not limited to, a biggest frame field depth BD, a smallest frame field depth SD, a mean frame field depth MD of the target video, and field depths D1, D2, D3 . . . Dn of the various data frames, wherein the biggest frame field depth BD is the maximum among the field depths D1, D2, D3 . . . Dn of all the data frames; the smallest frame field depth SD is the minimum among field depths D1, D2, D3 . . . Dn of all the data frames; the mean frame field depth MD of the target video is a corresponding mean of the field depths D1, D2, D3 . . . Dn of all the data frames.

The VR cinema system based on the mobile terminal may determine target scaling information S according to the reveal size information of the data frames and the frame field depth information D. The frame field depth information D may be used to scale up or down the field depth of each data frame of the target video to generate the field depth of each piece of data of the target video to be revealed on a screen. Specifically, the VR cinema system based on the mobile terminal calculates the frame field depth information D of the target video by using the target scaling information S to generate reveal field depth information RD corresponding to the target video. As a specific example of the present disclosure, the product of the target scaling information and the frame field depth information D is taken as the reveal field depth information RD, which is equivalent to RD=D*S; for example, if the field depth of the first data frame of the target field is D1, the field depth of the first data frame of the target field to be revealed on the screen is RD1, and RD1=D*S.

The reveal field depth information RD may include, but is not limited to, a biggest reveal field depth BRD, a smallest reveal field depth SRD, a mean reveal field depth MRD, and field depths RD1, RD2, RD3 . . . RDn of various data frames to be reveled on a screen, wherein the biggest reveal field depth BRD is the maximum among the field depths RD1, RD2, RD3 . . . RDn of all the data frames when revealed on the screen; the smallest reveal field depth BRD is the minimum among the field depths RD1, RD2, RD3 . . . RDn of all the data frames when revealed on the screen; the mean reveal field depth MRD of the target video is the corresponding mean of the field depths RD1, RD2, RD3 . . . RDn of all the data frames when revealed on the screen.

It needs to be noted that the mobile terminal is a computer device that can be used while moving, for example, a smart phone, a notebook computer, a tablet computer, and the like, which is not limited in this embodiment of the present disclosure. Detailed descriptions are made in this embodiment of the present disclosure by taking a mobile phone as an example.

In one preferred embodiment of the present disclosure, the above step 101 may specifically include: detecting the data frames of the target video to determine the reveal size information and the frame field depth information of the data frames; determining target scaling information according to the reveal size information and the frame field depth information; calculating the frame field depth information on the basis of the target scaling information to determine the reveal field depth information.

Step 103, the position information of a target seat is adjusted according to the reveal field depth information and a preset ideal visual distance.

In specific implementation, the VR cinema system based on the mobile phone may preset the ideal visual distance, such that played video contents are not directly shown in front of the eyes of an audience, and the audience can reach out to now playing video contents. Preferably, the VR system based on the mobile phone may set the preset ideal visual distance as the ideal smallest visual distance 0.5 for a user to watch a film. Besides, the VR cinema system based on the mobile phone may also preset screen position information as (X0, Y0, Z0), wherein X0 represents X-coordinate of the position of the screen in three-dimensional coordinates, while Y0 represents Y-coordinate of the position of the screen in the three-dimensional coordinates, and Z0 represents Z-coordinate of the position of the screen in three-dimensional coordinates.

The VR cinema system based on the mobile phone may adjust the position information of the target seat according to the reveal field depth information RD corresponding to the target video and the preset ideal visual distance, wherein the target seat is a virtual seat set for an audience in the VR cinema. Specifically, in the VR cinema system, the position information of the target seat may be set as (X1, Y1, Z1), wherein X1 represents X-coordinate of the position of the target seat in three-dimensional coordinates, while Y1 represents Y-coordinate of the position of the target seat in the three-dimensional coordinates, and Z1 represents Z-coordinate of the position of the target seat in the three-dimensional coordinates. Preferably, the value of X1 is set to the value of X0, the value of Y1 is set to the value of Y0, and the value of Z1 is set to the difference value of Z0 and variation information VD, i.e., Z1=Z0−VD.

In the VR cinema, the position of the screen may be fixed, i.e., the values of X0, Y0, and Z0 are constant. The value of Z1 may be varied by changing the value of the variation information VD; equivalently, the position information (X1, Y1, Z1) of the target seat may be adjusted. The variation information VD therein may be determined according to the reveal field depth information RD and the preset ideal visual distance.

In a preferred embodiment of the present disclosure, the above step 103 may specifically include: calculating a difference value between the smallest reveal field depth and the ideal visual distance to determine a reveal field depth change value; calculating a difference value between the biggest reveal field depth and the reveal field depth change value to determine variation information of the target seat; adjusting the position information of the target seat on the basis of the variation information to generate the adjusted position information.

Step 105, the target video is played on the screen on the basis of the adjusted position information.

Specifically, after the VR cinema system based on the mobile phone dynamically adjusts the position of the virtual audience seat with regard to the field depth range of the target video, an angle of field of view of a target audience when watching the target field can be determined on the basis of the adjusted position information; thus, the data frames of the target video can be rendered on the basis of the determined angle of field of view and the target video can be played on the display screen of the mobile phone.

In this embodiment of the present disclosure, the VR cinema system based on a mobile terminal is capable of determining the reveal field depth information corresponding to the target video by detecting the data frames of the target video, and adjusting the position information of the target seat according to the reveal field depth information and the ideal visual distance, namely adjusting the position of the audience seat with regard to the field depth information of different videos, thereby dynamically adjusting the distance between the audience seat and the screen in the virtual cinema; in such a way, the audience is enabled to be within a reasonable visual distance range and thus can obtain the best film-watching experience; as a result, the problem of poor 3D effect of playing due to the fixed position of the audience seat in the virtual cinema is solved, the 3D effect of playing videos on the mobile terminal is guaranteed, and the film-watching experience of the user is enhanced.

By referring to FIG. 2, illustrated is a step flow diagram of an embodiment of a processing method for playing a video of the present disclosure. Specifically, the following steps may be included.

Step 201, detection is performed on data frames of a target video to determine reveal field depth information and frame field depth information of the data frames.

Specifically, a VR cinema system based on a mobile terminal detects the data frames of the target video to obtain a width W and a height H of each data frame, and regards the widths W and the heights H as the reveal field depth information of the data frames.

In a 3D video, the same data frame has left and right images, which have a difference value at the same coordinate point; the field depth of the data frame may be obtained by calculating the difference value between the two images of the same data frame. For example, in three-dimensional coordinates, the difference value of the two images of each data frame in X-coordinates is calculated to obtain the field depths of various data frames, such as D1, D2, D3 . . . Dn. The frame field depth information of the target video may be determined on the basis of the field depths D1, D2, D3 . . . Dn of the various data frames of the target video: the frame field depth information may include a biggest depth BD, a smallest frame field depth SD, a mean frame field depth MD, and so on.

The VR cinema system based on the mobile phone may preset a sampling event, and then may obtain the data frames of the target video according to the sampling event, and calculate each obtained data frame to obtain the field depth of each data frame. The frame field depth information of the target field may be determined by collecting the obtained field depths of the various data frames. Generally, the highlight scenes of a 3D video may be presented together at the beginning or the end thereof. As a specific example of the present disclosure, the VR cinema system based on the mobile phone may set the sampling event to sample the data frames of 1.5 minutes at the beginning and the data frames of 1.5 minutes at the end, and may determine the field depth range of the target video by calculating the field depths of the various sampled data frames. Specifically, the data frames of 1.5 minutes at the beginning of the target video and the data frames of 1.5 minutes at the end of the same are sampled every 6 ms. For each data frame, the field depth of the data frame may be determined by calculating the X-coordinate difference value of the two images of the data frame in the three-dimensional coordinates, and then is recorded. For example, the field depth of the first sampled data frame is recorded as D1, the field depth of the second sampled data frame is recorded as D2, the field depth of the third sampled data frame is recorded as D3, . . . , and similarly, the field depth of the n-th sampled data frame is recorded as Dn. The field depths D1, D2, D3 . . . Dn of all the sampled data frames are collected, such that a smallest frame field depth SD, a mean frame field depth MD, and a biggest frame field depth BD can be determined.

Step 203, target scaling information is determined according to the reveal size information and the flame field depth information.

In a preferred embodiment of the present disclosure, the above step 201 may specifically include the substeps as follows.

Substep 2030, the frame field depth information is calculated to determine a frame field depth change value.

The frame field depth range (SD, BD) of the target video may be obtained by determining the smallest frame field depth SD and the biggest frame field depth BD; and the difference value between the biggest frame field depth BD and the smallest frame field depth SD may be regarded as the frame field depth change value.

Substep 2032, a ratio of preset screen size information to the reveal size information is calculated to determine a reveal scaling coefficient of the frame field depth information.

Usually, the VR cinema system based on the mobile phone may preset screen size information during displaying, wherein the screen size information may include width W0, height H0, and the like of the screen; for example, the width W0 and the height H0 of the screen may be set according to the length and width of the display screen of the mobile phone. A width scaling coefficient SW may be obtained by calculating a ratio of the width W0 of the screen to the width W of each data frame, which is equivalent to SW=W0/W; a height scaling coefficient SH may be obtained by calculating a ratio of the height H0 of the screen to the height H of each data frame, which is equivalent to SH=H0/H. The VR cinema system based on the mobile phone may regard the width scaling coefficient SW or the height scaling coefficient SH as a reveal scaling coefficient S of the frame field depth information, which is not limited in this embodiment of the present disclosure. Preferably, the width scaling coefficient SW is compared with the height scaling coefficient SH; when the width scaling coefficient SW is smaller than the height scaling coefficient SH, the width scaling coefficient SW may be regarded as the reveal scaling coefficient S0 of the frame field depth information; when the width scaling coefficient SW is not smaller than the height scaling coefficient SH, the height scaling coefficient SH may be regarded as the reveal scaling coefficient S0 of the frame field depth information.

Substep 2034, the target scaling information is determined on the basis of the frame field depth change value and the reveal scaling coefficient.

In a preferred embodiment of the present disclosure, the above substep 2034 may specifically include: determining whether the frame field depth change value is up to a preset field depth change standard; regarding the reveal scaling coefficient as the target scaling information when the frame field depth change value is up to the preset field depth change standard; when the frame field depth change value is not up to the preset field depth change standard, determining a scaling-up coefficient according to a preset target field depth change rule, and regarding the product of the scaling-up coefficient and the reveal scaling coefficient as the target scaling information.

In this embodiment of the present disclosure, when the frame field depth range of the target video is relatively narrow, the field depth range of the target video may be scaled up to ensure the 3D effect of playing the target video. Specifically, the VR cinema system based on the mobile phone may preset the field depth change standard by means of which whether the frame field depth range of the target video needs to be scaled up may be determined. When the frame field depth change value of the target video is up to the preset field depth change standard, i.e., the frame field depth range of the target video does not need to be scaled up, the reveal scaling coefficient S0 may be regarded as the target scaling information of the target video, which is equivalent to S=S0; when the frame field depth change value is not up to the preset field depth change standard, i.e., the frame field depth range of the target video needs to be scaled up, the scaling-up coefficient is determined according to the preset target field depth change rule, and the product of the scaling-up coefficient S1 and the reveal scaling coefficient S0 is regarded as the target scaling information S, i.e., S−S1*S0.

The target field depth change rule therein is used for determining the scaling-up coefficient S1 according to the frame field depth change value of the target video. The scaling-up coefficient S1 may be used for processing the data frames of the target video, and the field depths of the data frames may be scaled up according to the scaling-up coefficient S1; also, it may be used for scaling up a preset screen size, namely scaling up the width W0 and the height H0 of the screen according to the scaling-up coefficient S1; in this way, the field depth range of the target video can be scaled up to ensure the 3D effect of playing the target video.

Step 205, the frame field depth information is calculated on the basis of the target scaling information to determine the reveal field depth information.

In a preferred embodiment of the present disclosure, the frame field depth information may include the smallest frame field depth and the biggest frame field depth; the step 205 may specifically include the sub-steps as follows.

Substep 2050, the product of the scaling information and the smallest frame field depth is calculated to determine a smallest reveal field depth.

In this embodiment of the present disclosure, the VR cinema system based on the mobile phone may obtain the product of the scaling information S and the smallest frame field depth SD through calculation, and regard the product of the scaling information S and the smallest frame field depth SD as the smallest field depth of the target video when revealed on the screen, namely determining the product of the scaling information S and the smallest frame field depth SD as the smallest reveal field depth SRD.

Substep 2052, the product of the scaling information and the biggest frame field depth is calculated to determine a biggest reveal field depth.

The VR cinema system based on the mobile phone may also obtain the product of the scaling information S and the biggest frame field depth BD through calculation, and regard the product of the scaling information S and the biggest frame field depth BD as the biggest field depth of the target video when revealed on the screen, namely determining the product of the scaling information S and the biggest frame field depth BD as the biggest reveal field depth BRD.

Step 207, a difference value between the smallest reveal field depth and the ideal visual distance is calculated to determine a reveal field depth change value.

In this embodiment of the present disclosure, the ideal visual distance preset by the VR cinema system based on the mobile phone is 0.5 m. By means of calculation, the difference value between the smallest reveal field depth SRD of the target video and the ideal visual distance 0.5 m may be obtained, which is regarded as the reveal field depth change value VRD, i.e., VRD=SRD−0.5 (m).

Step 209, a difference value between the biggest reveal field depth and the reveal field depth change value is calculated to determine variation information of a target seat.

The VR cinema system based on the mobile phone may obtain the difference value between the biggest reveal field depth BRD and the reveal field depth change value VRD through calculation, and regard the difference value between the biggest reveal field depth and the reveal field depth change value as the variation information VD of the target seat, i.e., VD=BRD−SRD+0.5 (m); it is equivalent to that the variation information of the target seat is determined with regard to the field depth range of the target video revealed on the screen, and then the distance between the target seat and the screen in the virtual cinema may be dynamically adjusted.

Step 211, the position information of the target seat is adjusted on the basis of the variation information to generate the adjusted position information.

As shown in the above example, the VR cinema system based on the mobile phone sets the position information of the target seat as (X1, Y1, Z1), wherein the value of X1 may be set to the value of X0, and the value of Y1 may be set to the value of Y0, i.e., X1 and Y1 may be fixed; the value of Z1 may be set to the difference value of Z0 and the variation information VD, i.e., Z1=Z0−VD; equivalently, the position information of the target seat is varied by changing the value of the variation information VD. Hence, the VR cinema system based on the mobile phone may adjust the position information (X1, Y1, Z1) of the target seat by means of the variation information VD, and generate the adjusted position information (X1, Y1, Z0−VD).

Step 213, the target video is played on the screen on the basis of the adjusted position information.

In this embodiment of the present disclosure, the VR cinema system based on the mobile phone, after dynamically adjusting the position of the virtual audience seat with regard to the field depth range of the target video, may play the target video on the screen on the basis of the adjusted position information.

In this embodiment of the present disclosure, the frame data of the target video is detected to determine the field depth range of the target video revealed on the screen, the variation information of the audience seat is generated according to the field depth range, and the audience seat is adjusted on the basis of the variation information; equivalently, the distance between the seat and the screen in the virtual cinema is dynamically adjusted with regard to the field depth range of the target video, i.e., the visual distance of the audience is automatically adjusted, such that the audience is enabled to be within a reasonable visual distance range and thus can obtain the best film-watching experience; as a result, the 3D effect of playing the target video on the mobile terminal is guaranteed.

It needs to be noted that with respect to the method embodiments, for the sake of simple descriptions, they are all expressed as combinations of a series of actions; however, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description all are preferred embodiments, and the actions involved therein are not necessary for the embodiments of the present disclosure.

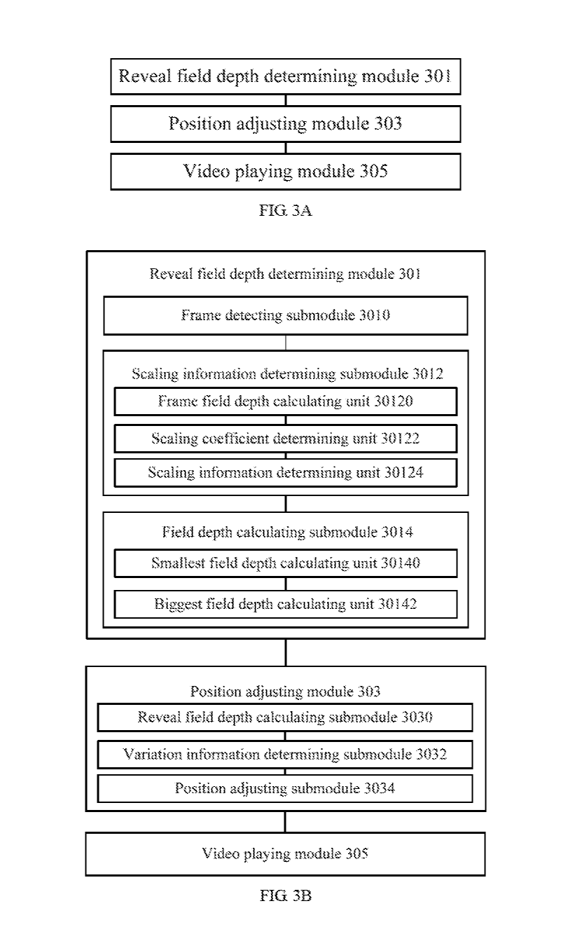

By referring to FIG. 3A, illustrated is a structural block diagram of an embodiment of a processing device for playing a video of the present disclosure; specifically, the processing device may include the following modules:

a reveal field depth determining module 301, configured to detect data frames of a target video to determine reveal field depth information corresponding to the target video;

a position adjusting module 303, configured to adjust position information of a target seat according to the reveal field depth information and a preset ideal visual distance:

a video playing module 305, configured to play the target video on a screen on the basis of the adjusted position information.

Based on FIG. 3A, optionally, the reveal field depth determining module 301 may include a frame detecting submodule 3010, a scaling information determining submodule 3012, and a field depth calculating submodule 3014, as shown in FIG. 3B.

The frame detecting submodule 3010 may be configured to detect the data frames of the target video to determine the reveal size information and frame field depth information of the data frames.

The scaling information determining submodule 3012 may be configured to determine target scaling information according to the reveal size information and the frame field depth information.

In a preferred embodiment of the present disclosure, the scaling information determining submodule 3012 may include the following units:

a frame field depth calculating unit 30120, configured to calculate the frame field depth information to determine a frame field depth change value;

a scaling coefficient determining unit 30122, configured to calculate a ratio of preset screen size information to the reveal size information to determine a reveal scaling coefficient of the frame field depth information;

a scaling information determining unit 30124, configured to determine the target scaling information on the basis of the frame field depth change value and the reveal scaling coefficient.

Preferably, the scaling information determining unit 30124 is specifically configured to: determine whether the frame field depth change value is up to a preset field depth change standard; regard the reveal scaling coefficient as the target scaling information when the frame field depth change value is up to the preset field depth change standard; and when the frame field depth change value is not up to the preset field depth change standard, determine an amplification coefficient according to a preset target field depth change rule, and regard the product of the amplification coefficient and the reveal scaling coefficient as the target scaling information.

The field depth calculating submodule 3014 is configured to calculate the frame field depth information on the basis of the target scaling information to determine the reveal field depth information.

In a preferred embodiment of the present disclosure, the frame field depth information includes a smallest frame field depth and a biggest frame field depth. The field depth calculating submodule 3014 may include the following units:

a smallest field depth calculating unit 30140, configured to calculate the product of the scaling information and the smallest frame field depth to determine a smallest reveal field depth;

a biggest field depth calculating unit 30142, configured to calculate the product of the scaling information and the biggest frame field depth to determine a biggest reveal field depth.

Optionally, the position adjusting module 303 may include the following submodules:

a reveal field depth calculating submodule 3030, configured to calculate a difference value between the smallest reveal field depth and the ideal visual distance to determine a reveal field depth change value:

a variation information determining submodule 3032, configured to calculate a difference value between the biggest reveal field depth and the reveal field depth change value to determine variation information of the target seat;

a position adjusting submodule 3034, configured to adjust the position information of the target seat on the basis of the variation information to generate the adjusted position information.

For the device embodiment, as it is substantially similar to the method embodiments, the descriptions are relatively simple; for the relevant parts, just see part of descriptions of the method embodiments.

Each embodiment in the description is described in a progressive manner. Descriptions emphasize on the differences of each embodiment from other embodiments, and same or similar parts of various embodiments just refer to each other.

In addition, it should be noted that, although in the above illustration a mobile terminal is taken as an example, in practical application, the present disclosure may also be applied to various electronic devices, which is not limited to be the mobile terminal.

Each component embodiment of the present disclosure may be implemented by hardware or by a software module running on one or more processors, or by the combination therefor. It should be appreciated by a person skilled in the art that some or all functions of some or all components in the mobile terminal according to the embodiments of the present disclosure may be implemented by using a microprocessor or a digital signal processor (DSP) in practice. The present disclosure may also be implemented as a device or a device program (e.g., a computer program and a computer program product) for executing part or all of the method described herein. Such a program for implementing the present disclosure may be stored in a computer readable medium, or may be in the form of having one or more signals. Such signals may be downloaded from websites on the Internet, or provided by carrier signals, or provided in any other form.

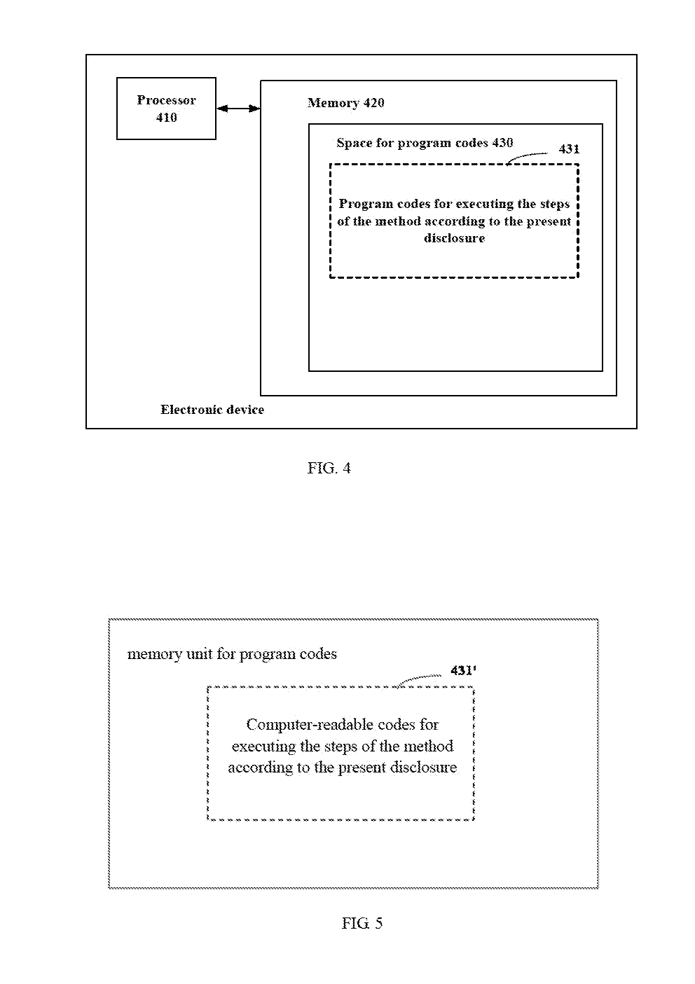

For example, FIG. 4 shows an electronic device, such as a mobile terminal, which is capable of implementing the processing method for playing the video according to the present disclosure. Traditionally, the electronic device includes a processor 410 and a computer program product or a computer readable medium in the form of a memory 420. The memory 420 may be one of electronic memories, such as a flash memory, an EEPROM (Electrically Erasable Programmable Read-Only Memory), an EPROM, a hard disk. ROM, and the like. The memory 420 is provided with a storage space 430 for program codes 431 for executing any method steps in the above method. For example, the storage space 430 for the program codes may include various program codes 431 for implementing various steps in the above method, respectively. These program codes may be read out of one or more computer program products or written in the one or more computer program products. These computer program products include program code carries such as a hard disk, a compact disk (CD), a memory card, a soft disk, and the like. Such a computer program product usually is, for example, a portable or fixed storage unit as shown in FIG. 5. The storage unit may have storage segments, storage spaces and the like arranged in a similar manner to that of the memory 420 in the electronic device in FIG. 4. The program codes may be compressed, for example, in an appropriate way. Usually, the storage unit includes computer readable codes 431′, namely codes readable by, for example, a processor such as 410 and the like; the codes are run by the electronic device, leading to that the electronic device to execute various steps in the method described above.

“An embodiment”, “embodiments” or “one or more embodiments” mentioned in this text means that specific features, structures or characteristics described in conjunction with the embodiments are included in at least one embodiment of the present disclosure. Besides, attention needs to be paid to that the word example “in an embodiment” herein does not necessarily refer to the same embodiment.

In the description provided herein, many specific details are illustrated. However, it can be understood that the embodiments of the present disclosure may be put into practice without these specific details. In some embodiments, publicly known methods, structures and technologies are not illustrated in detail so as not to dim the understanding of the description.

It should be noted that the above embodiments are intended to illustrate, rather than limiting, the present disclosure, and a person skilled in the art can design altenmative embodiments without departing from the scope of the attached claims. In the claims, any reference symbol in a bracket should not be regarded as limitation to the claims. The word “include” does not exclude any element or step not described in the claims. The word “an” or “one” before an element does not exclude that a plurality of such elements exist. The present disclosure may be implemented by means of hardware including a plurality of different elements and by means of an appropriately programmed computer. In unit claims where a plurality of devices are listed, several of these devices may be specifically embodied by means of the same hardware item. The words first, second, and third are used not to indicate any sequence. The words may be explained as names.

Besides, it should also be noted that words used in this description are mainly selected for the objectives of readability and teaching, not for explaining or limiting the subject matters of the present disclosure. Hence, it would be obvious for a person ordinarily skilled in the art of technology that many modifications and alternations can be made without departing from the scope and concept of the attached claims. For the scope of the present disclosure, the present disclosure is illustrative, not restrictive; the scope of the present disclosure is limited by the attached claims.

The embodiments of the present disclosure are described with reference to the flow diagrams and/or the block diagrams of the method, the terminal device (system), and the computer program product according to the embodiments of the present disclosure. It should be appreciated that computer program commands may be adopted to implement each flow and/or block in each flow diagram and/or each block diagram, and the combination of the flows and/or the blocks in each flow diagram and/or each block diagram. These computer program commands may be provided to a universal computer, a special purpose computer, an embedded processor or a processor of another programmable data processing terminal equipment to generate a machine, such that the commands executed by the computer or the processor of another programmable data processing terminal equipment create a device for implementing functions specified in one flow or multiple flows of each flow diagram and/or one block or multiple blocks of each block diagram.

These computer program commands may also be stored in a computer readable memory that is capable of guiding the computer or another programmable data processing terminal equipment to work in a specified mode, such that the commands stored in the computer readable memory create a manufacture including a command device for implementing functions specified in one flow or multiple flows of each flow diagram and/or one block or multiple blocks of each block diagram.

Further, these computer program commands may be loaded on the computer or another programmable data processing terminal equipment, such that a series operation steps are executed on the computer or another programmable data processing terminal equipment to generate processing implemented by the computer; in this way, the commands executed on the computer or another programmable data processing terminal equipment provide steps for implementing functions specified in one flow or multiple flows of each flow diagram and/or one block or multiple blocks of each block diagram.

The processing method for playing a video and a processing device for playing a video provided by the present disclosure are introduced above in detail. In this text, specific examples are utilized to elaborate the principle and the embodiments of the present disclosure; the above descriptions of the embodiments are merely intended to help understanding the method of the present disclosure and the core concept thereof, meanwhile, for a person ordinarily skilled in the art, alterations may be made to the specific embodiments and the application scope according to the concept of the present disclosure. In conclusion, the contents of this description should not be understood as limitations to the present disclosure.

What is claimed is:

1. A processing method for playing a video, applied to a mobile terminal, comprising:
detecting data frames of a target video to determine reveal field depth information corresponding to the target video;
adjusting position information of a target seat according to the reveal field depth information and a preset ideal visual distance;
playing the target video on a screen on the basis of the adjusted position information.

2. The method according to claim 1, wherein detecting the data frames of the target video to determine the reveal field depth information corresponding to the target video comprises:
detecting the data frames of the target video to determine reveal size information and frame field depth information of the data frames;
determining target scaling information according to the reveal size information and the frame field depth information;
calculating the frame field depth information on the basis of the target scaling information to determine the reveal field depth information.

3. The method according to claim 2, wherein determining target scaling information according to the reveal size information and the frame field depth information comprises:
calculating the frame field depth information to determine a frame field depth change value;
calculating a ratio of preset screen size information to the reveal size information to determine a reveal scaling coefficient of the frame field depth information;
determining the target scaling information on the basis of the frame field depth change value and the reveal scaling coefficient.

4. The method according to claim 3, wherein determining the target scaling information on the basis of the frame field depth change value and the reveal scaling coefficient comprises:
determining whether the frame field depth change value is up to a preset field depth change standard;
regarding the reveal scaling coefficient as the target scaling information when the frame field depth change value is up to the preset field depth change standard;
when the frame field depth change value is not up to the preset field depth change standard, determining a scaling-up coefficient according to a preset target field depth change rule, and regarding the product of the scaling-up coefficient and the reveal scaling coefficient as the target scaling information.

5. The method according to claim 2, wherein the frame field depth information comprises a smallest frame field depth and a biggest frame field depth;
calculating the frame field depth information on the basis of the target scaling information to determine the reveal field depth information comprises:
calculating the product of the scaling information and the smallest frame field depth to determine a smallest reveal field depth;
calculating the product of the scaling information and the biggest frame field depth to determine a biggest reveal field depth.

6. The method according to claim 5, wherein adjusting the position information of the target seat according to the reveal field depth information and the preset ideal visual distance comprises:
calculating a difference value between the smallest reveal field depth and the ideal visual distance to determine a reveal field depth change value;
calculating a difference value between the biggest reveal field depth and the reveal field depth change value to determine variation information of the target seat;
adjusting the position information of the target seat on the basis of the variation information to generate the adjusted position information.

7. An electronic device for playing a video, comprising:
at least one processor; and
a memory communicably connected with the at least one processor for storing instructions executable by the at least one processor, wherein execution of the instructions by the at least one processor causes the at least one processor to:
detect data frames of a target video to determine reveal field depth information corresponding to the target video;
adjust position information of a target seat according to the reveal field depth information and a preset ideal visual distance;
play the target video on a screen on the basis of the adjusted position information.

8. The electronic device according to claim 7, wherein the step to detect data frames of a target video to determine reveal field depth information corresponding to the target video comprises:
detect the data frames of the target video to determine the reveal size information and frame field depth information of the data frames;
determine target scaling information according to the reveal size information and the frame field depth information,
calculate the frame field depth information on the basis of the target scaling information to determine the reveal field depth information.

9. The electronic device according to claim 8, wherein the step to determine target scaling information according to the reveal size information and the frame field depth information comprises:
calculate the frame field depth information to determine a frame field depth change value;
calculate a ratio of preset screen size information to the reveal size information to determine a reveal scaling coefficient of the frame field depth information;
determine the target scaling information on the basis of the frame field depth change value and the reveal scaling coefficient.

10. The electronic device according to claim 9, wherein the step to determine the target scaling information on the basis of the frame field depth change value and the reveal scaling coefficient comprises: determine whether the frame field depth change value is up to a preset field depth change standard; regard the reveal scaling coefficient as the target scaling information when the frame field depth change value is up to the preset field depth change standard; and when the frame field depth change value is not up to the preset field depth change standard, determine a scaling-up coefficient according to a preset target field depth change rule, and regard the product of the scaling-up coefficient and the reveal scaling coefficient as the target scaling information.

11. The electronic device according to claim 8, wherein the frame field depth information comprises a smallest frame field depth and a biggest frame field depth; the step to calculate the frame field depth information on the basis of the target scaling information to determine the reveal field depth information comprises:
calculate the product of the scaling information and the smallest frame field depth to determine a smallest reveal field depth;
calculate the product of the scaling information and the biggest frame field depth to determine a biggest reveal field depth.

12. The electronic device according to claim 11, wherein the step to adjust position information of a target seat according to the reveal field depth information and a preset ideal visual distance comprises:
calculate a difference value between the smallest reveal field depth and the ideal visual distance to determine a reveal field depth change value;
calculate a difference value between the biggest reveal field depth and the reveal field depth change value to determine variation information of the target seat;
adjust the position information of the target seat on the basis of the variation information to generate the adjusted position information.

13. A non-transitory computer-readable medium storing executable instructions that, when executed by an electronic device, cause the electronic device to:
detect data frames of a target video to determine reveal field depth information corresponding to the target video;
adjust position information of a target seat according to the reveal field depth information and a preset ideal visual distance;
play the target video on a screen on the basis of the adjusted position information.

14. The non-transitory computer-readable medium according to claim 13, wherein the step to detect the data frames of the target video to determine the reveal field depth information corresponding to the target video comprises:
detect the data frames of the target video to determine reveal size information and frame field depth information of the data frames;
determine target scaling information according to the reveal size information and the frame field depth information;
calculate the frame field depth information on the basis of the target scaling information to determine the reveal field depth information.

15. The non-transitory computer-readable medium according to claim 14, wherein the step to determine target scaling information according to the reveal size information and the frame field depth information comprises:
calculate the frame field depth information to determine a frame field depth change value;
calculate a ratio of preset screen size information to the reveal size information to determine a reveal scaling coefficient of the frame field depth information;
determine the target scaling information on the basis of the frame field depth change value and the reveal scaling coefficient.

16. The non-transitory computer-readable medium according to claim 15, wherein the step to determine the target scaling information on the basis of the frame field depth change value and the reveal scaling coefficient comprises:
determine whether the frame field depth change value is up to a preset field depth change standard;
regard the reveal scaling coefficient as the target scaling information when the frame field depth change value is up to the preset field depth change standard;
when the flame field depth change value is not up to the preset field depth change standard, determine a scaling-up coefficient according to a preset target field depth change rule, and regard the product of the scaling-up coefficient and the reveal scaling coefficient as the target scaling information.

17. The on-transitory computer-readable medium according to claim 14, wherein the frame field depth information comprises a smallest frame field depth and a biggest frame field depth;
the step to calculate the frame field depth information on the basis of the target scaling information to determine the reveal field depth information comprises:
calculate the product of the scaling information and the smallest frame field depth to determine a smallest reveal field depth;
calculate the product of the scaling information and the biggest frame field depth to determine a biggest reveal field depth.

18. The non-transitory computer-readable medium according claim 17, wherein the step to adjust the position information of the target seat according to the reveal field depth information and the preset ideal visual distance comprises:
calculate a difference value between the smallest reveal field depth and the ideal visual distance to determine a reveal field depth change value;
calculate a difference value between the biggest reveal field depth and the reveal field depth change value to determine variation information of the target seat;
adjust the position information of the target seat on the basis of the variation information to generate the adjusted position information.
